(19) United States
(12) Patent Application Publication
(10) Pub. No.: US 2018/0121866 A1
(43) Pub. Date: May 3, 2018

(54) INVENTORY MANAGEMENT SYSTEM USING INDIVIDUAL MODULES

(71) Applicant: Cubex LLC, Phoenix, AZ (US)

(72) Inventors: John D. HIGHAM, Menlo Park, CA (US); Anton C. VISSER, Newport Beach, CA (US); Rob J. NEWSOM, Chandler, AZ (US); Aaron S. NALICK, Mesa, AZ (US); Laura G. BROWN, Gilbert, AZ (US)

(73) Assignee: Cubex LLC, Phoenix, AZ (US)

(21) Appl. No.: 15/336,262

(22) Filed: Oct. 27, 2016

(51) Int. Cl. G06Q 10/08; G06F 3/0481; G06F 3/0482; G06F 3/0488

(52) U.S. Cl. CPC G06Q 10/087; G06F 3/0488; G06F 3/0482; G06F 3/04817

(57) ABSTRACT

Inventory management systems using individual modules are described where the system utilizes one or more wireless-connected button modules in which one button module may be located at each item shelf location. The button module is able to transmit and receive wireless signals to and from a central console. Each button module may have at least two buttons, one for removing stock, one for adding. For selected, authorized users, the mode of operation of the button module may be changed in order to perform other functions. The button module may also include either a small alphanumeric display or a bitmap display allowing alphanumeric text of any size and the ability to also display status icons where appropriate. Each button module may also have an LED alert light, a piezo beeper, and the ability to interact with a user via an NFC or RFID chip.

### FIELD OF THE INVENTION

The present invention relates to inventory management systems used to track the quantity of items taken or replaced from the inventory. More specifically, the present invention relates to an inventory management system which can be used to wirelessly record multiple inventory items using one or more button modules, and the associated functionality.

### BACKGROUND OF THE INVENTION

There are many methods for tracking who takes, returns or restocks items in a store room warehouse or final point of use, in order to maintain a record of the on-hand quantity, and to monitor that quantity in order to place orders to replenish stock. A typical system comprises a computer with a database storing information about each item, and means for users to interact with that database, to maintain a computer based numerical representation of what is actually physically on the shelves. The maintenance of that information in the computer, which is referred to as a perpetual inventory system, is a common process today. In order to maintain the perpetual inventory, early systems required a user interacting with the inventory, to also interact with a nearby computer terminal, either before or after visiting the location of the material they are taking, and input information about what they did.

For busy stock rooms, and particularly large warehouses, having a fixed terminal entry requiring multiple users to remember or note down what they did at multiple item locations, and return to a fixed location to enter data into a computer terminal, is at best inconvenient, and at worst will be a process that users are unlikely to consistently follow. The same is true of a supervisor's maintenance functions, such as assigning or de-assigning an item to a location, entering the maximum and minimum levels required, and performing routine check functions such as a physical inventory count (a.k.a. cycle counting). All these operations would be more conveniently done at the location where the item is located on a shelf or in a bin, physically remote from any fixed computer terminal(s).

There are a number of ways in which this problem has been solved when the item locations are remote from a computer terminal. One has been to provide portable intelligent bar code scanners that communicate with the base computer and where information can be entered on the scanner screens. More recently portable tablet computers or mobile devices have been employed. For applications in a warehouse environment, such systems are successfully used by people who are specifically trained for that function, and where the investment of purchasing equipment for a small number of full-time trained people is worthwhile.

Inventory management at the final point of use however is more challenging. This may be in a manufacturing plant, an office, a clinic, a hospital or anywhere where supplies are consumed during the work-day. In these cases, the people taking the products usually need quick and easy access to supplies in their work area, and having many other duties, do not want to be burdened with lengthy procedures to get at the products they need. More importantly it is impractical with a large and changing staff to keep them trained on using complex equipment like bar code terminals. In spite of that, ideally it would be beneficial to accurately maintain exact inventory levels at these points of use. When justifiable, this can be achieved with relative simplicity for the user by locked automated dispensing cabinets that only dispense one item at a time, after a user has logged into a computer interlace that is embedded in the cabinet, allowing identification of a specific item taken, and who took it. This kind of equipment is useful for expensive items, or items such as narcotics that require regulatory control, but is too expensive for many low cost supplies.

The next level of control is to require a user to log into a secure cabinet and select the items and quantities they will be taking from a list, and give them access to compartments that contain Multiple quantities of those items, or even multiple items. The user can of course take more than they said they were taking, but if the product is not something that might be of use to that person outside of their work, most users are motivated to make sure that the product is accurately counted to ensure re-order, and hence future availability when needed, These cabinet solutions are still prohibitively expensive for low cost or bulky items. More frequently such items are simply stored in bins or on shelving or in drawers. In these circumstances, if the restock process requires someone to check product levels on a regular basis, that checking is costly in labor, and stock-outs can be frequent.

Various systems have been devised to enable easier tracking of stock levels in an open system. As suggested earlier, systems that require bar code scanning that might be effective in a warehouse, are not effective at the point of use because they require training, and the extra time required to perform that scanning is a time burden on users who have many other responsibilities. Having a stack of re-order cards in each item bin allows a user to place the card in a re-order box for someone to pick up, if the user sees the bin is getting low on stock. Other systems include Kanban, where there are two bins for every product, and when one is empty, it is place in a location where materials staff pick them up and replenish them, or they are placed on a RFID reading tray and an RFID tag on the empty bin is read, which then electronically orders a replacement bin. The Kanban system can be effective where there is room for two bins for every product, but is inefficient, costly for expensive product, and impractical for a product that is bulky and which would require the extra storage of the two-bin Kanban system. Ideally in these circumstances we would like an open system (thus avoiding the cost of a locked cabinet), but where the exact inventory is maintained. Maintaining this perpetual inventory record, allows the computer system to re-order the product in sufficient time to prevent a stock-out, but without the need to carry a large amount of excess inventory.

Locked cabinet systems have been developed that make a pair of buttons available at each inventory location to indicate the taking or returning of an item. The Take or Return button is pushed once for each item taken. This assumes that the user will take the trouble to comply, and since the process is so simple and takes so little time, this is usually achieved. It also assumes that the user is only taking one or two items, and does not have to press the button a large number of times, which can be time consuming and potentially inaccurate. Because there is a device at each location, the cost of such a device needs to be kept very low. Consequently, other functions which require being physically present at the location of the product, such as inventory verification counting (a.k.a. cycle-counting), restocking and destocking, still need access to a computer terminal that is usually remote, for data entry.

### SUMMARY OF THE INVENTION

The invention relates to a system that comprises wireless-connected button modules, one button module semi-permanently located at each item shelf location, able to transmit and receive wireless signals to and from a central console, that central console comprising at least a processor, database and user interface. To make the installation of a large number of these button modules on shelving practical, they are powered by batteries, and communicate to the central console using very low power wireless signals. Each button module has at least two buttons, one for removing stock, one for adding. For selected, authorized users, it is desirable to change the mode of operation of the button module in order to perform other functions, other than the Take and Return of stock, and where the function of the Take button becomes that of decreasing any number to be adjusted, and the Return button becomes that of increasing any number to be adjusted. Access to these administration functions can be provided by a third administration button, or by holding down the Take and Return button simultaneously for a period of time, which action can be detected by the button module firmware, allowing it to detect a desire by the user to change the mode of operation. For the purposes of this application the workflows assume a separate third administration button. The button module also includes either a small alphanumeric display or preferably a bitmap display allowing alphanumeric text of any size with numbers shown much larger than text and the ability to also display status icons where appropriate. Each button module may also have an LED alert light, a piezo beeper, and the ability to interact with a user via an NFC or RFID chip.

Since the buttons are intended for use on open shelving in a small stock room, if it is required that items are tracked to a specific user, then only one user can be logged into the central console at a time. Where users do not need to log in, the button modules can track the quantity on hand taken by multiple users simultaneously, but in the device described here will not be able to determine who is using the module. Other invention applications describe the button module as containing an NFC chip, which could be used for individual identification if the user was using an NFC communication device or badge read and recognized at each button module. The remaining description assumes the situation where the product is being identified to a single user at a time.

In normal, everyday use, the name of the product and other identifying information related to the item, may be shown on the button module display, and typically also a numeric display of the quantity on hand that the computer has in its memory. A new user may use the displayed information to determine the correct product, but typically a user is visually identifying the product they wish to take by looking at the product itself on the shelf, and then doing no more than pressing the Take or Return button at that shelf location to record their action. A user with administrative privileges, however may either casually, or as part of a routine cycle count, observe the display of on hand quantity, and compare that to the amount on the shelf, and if there is a discrepancy they may put the button module into cycle count mode and adjust the number using the Take and Return buttons in a different mode, as buttons that simply increase or decrease the computer value of inventory on hand, without recording an issue or return of product. Access to this administrative function of cycle counting is reached by pressing the administration button a certain number of times in rapid succession, the number of presses determining the administration function to be selected.

Another administration function is for the restocking or destocking of items, allowing the administration user to enter the number of items that they are restocking at the button module without having to pre-enter the number at a computer terminal remote from the item location. In this case the display can show the number of times the button has been pushed, representing the amount being restocked, allowing the administration user to confirm they have entered the right quantity. Further the display allows the button to operate in typematic mode, so that if the button is held down, then after a short delay to distinguish the held finger from a single button push, the number scrolls rapidly up (or down). For large numbers, this lets the user get close to the number then adjust the number to be exact with individual up or down button pushes. In other cases, it is convenient to provide an administration function that allows instant ordering. If for example the button module shows that there are ten items on hand but an administration user sees there are only a few left on the shelf, they have two options. One is to correct the count and let the normal ordering system order the item. However, a regular ordering system may only re-order once a week. So an alternative is to provide an administration function for immediate reorder. This would for example, allow the computer system to place the order immediately or at the end of the day, causing the distributor to expedite replacement items overnight.

The actions described are based on observations at the button module. Functions of cycle-counting and restocking are frequent and usually executed on a routine basis, but there are still advantages to the features of this invention. When the items from a large purchase order are received, the restock administration user can use the main central console to flash the lights on each button module which will need restocking. The central console can also cause the quantity of each item to be restocked to be displayed on the respective button module screens. In this way the user simply has to walk around the stock room, check that the displayed number is correct, adjust it up or down if it is not, press the administration button to have the number recorded in the central console, at which point the flashing LED light on that button module is switched off, and continue this process until all the LED lights are out. The beeper can also be energized. Sound is more difficult to locate physically, and multiple sounds particularly difficult, and so is redundant when there is a flashing light. However, when most of the items have been restocked and there are only one or two items left, the enabling of a beep signal for the remaining one or two items, even if they are hard to locate audibly, can alert the user to the fact that there are one or two flashing LED modules that they missed, and the need to look for them.

During each individual restock process, the display at the button module can show the amount that was ordered, and the administration restocker can check that is the quantity received and make any adjustment. Preferably, in this restock mode, the current quantity on hand is displayed first, available for correction. In this way before restocking the user can perform a cycle count, then push the admin button again, which will then cause the restock quantity to be displayed. In that way the system conveniently combines a cycle count with the restock function. A supplemental restock process is also described. This is for items that may not be associated with an electronic purchase order, and so the user simply needs to put the module into a restock mode where they can add a quantity of stock, and record it as restocking (not returning previously issued stock).

In large inventory situations it can be laborious to cycle count every item, and so it is desirable to do selective counts. This selection can be based on items that have been accessed since the last cycle count, or expensive items, or where the stock out would be critical. Such lists can be tracked and selected at a central console, and then, in the same way as was used for the restock process, the LED on the buttons to be counted can be flashed, and when the cycle counting is almost complete, the beeper can be energized on the remaining buttons to make sure all have been addressed.

In one variation a method for recording multiple inventory items by one or more users generally comprises providing a button module with at least two buttons, and a controllable alphanumeric or bit map display, where the power for the button module is from built in batteries and providing bi-directional communication means to a central console comprising a user interface, processor and database that may be local or in the cloud or both. The method further comprises displaying on a home screen alphanumeric text related to a physical inventory item adjacent to the location where the button module is placed, displaying one or more numbers on the screen relating to that item, detecting the pressing of either of the two buttons on the home screen and sending the number of times each has been pushed back to the central console, detecting the pressing of a third button at the module, and determining how many times it was pressed over a short period of time, and utilizing the number of presses of the third button within a short period of time to allow the central data base and user interface to modify what is displayed on the button module screen to perform different functions, each function uniquely corresponding to the number of times that third button was pushed during that short period of time.

In another variation, the Method for recording multiple inventory items may generally comprise displaying a count upon a display screen of a module, wherein the count corresponds to a number of a physical inventory items adjacent to a location of the module, detecting a first input from a user upon a first user interface of the module, wherein the first input is indicative of a change in the count displayed upon the display screen, transmitting the first input from the module to a central console located remotely from the module, detecting for a second input from the user upon a second user interface of the module, wherein the second input corresponds to a particular function depending upon a number of times the second user interface is actuated by the user, transmitting the second input from the module to the central console such that the central console processes both the first input and the second, and modifying the count displayed upon the display screen via a modifying signal received by the module from the central console.

### BRIEF DESCRIPTION OF THE DRAWINGS

FIG. 1 shows the front face of a typical button module.

FIG. 2 Shows the architecture of the system where Wi-Fi (or other wireless protocol) is the communication mechanism between each button module and a central console, either local, or in the cloud or both.

FIG. 3 Shows the architecture of the system where a sort distance communication network such as Zigbee or ZWave communicates signals from the button modules to repeaters and to a hub which in turn communicates via Wi-Fi or hard wired Ethernet to a central console, either local, or in the cloud or both.

FIG. 4 shows the sequence of states of the button module during a Take or Return function

FIG. 5 Shows the sequence of states of a button module during a cycle-count process

FIG. 6 Shows the sequence of states of a button module during an immediate re-order process

FIG. 7 Shows the sequence of states of a button module during a non-scheduled, supplemental restock or destock process

FIG. 8 Shows the sequence of states of a button module during a scheduled restock process

FIG. 9 Shows the sequence of states of a button module during a scheduled cycle count process

### DETAILED DESCRIPTION OF THE INVENTION

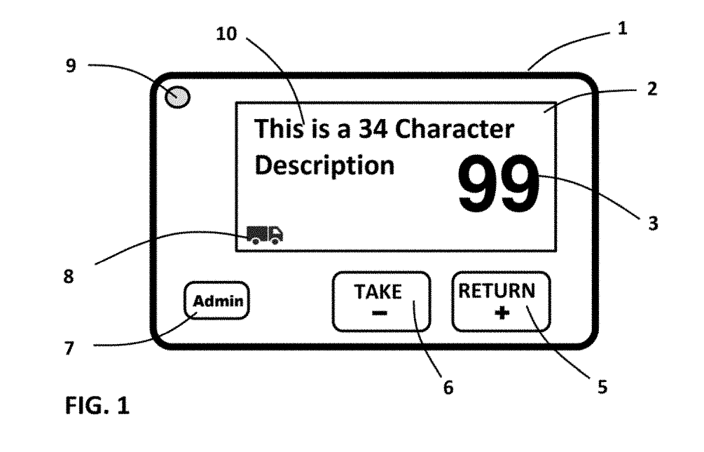

FIG. 1 shows an example of the elements on the front of a button module which is typically, e.g., about 2.5 inches by 1,75 inches by 0.5 inches deep, but which could be as small as technology allows or as large as needed for an application. These dimensions are not intended to be limiting but are presented as one example for a button module housing. A housing 1 contains the elements of the module, including a communications system such as Zigbee, ZWave or Wi-Fi, batteries typically of the coin type, a beeper, and processor and memory to drive the display and manage communications. The display 2, which can be an alphanumeric display but is preferably a low power electrophoretic ink, bit map display, allows any text 10 or number or numbers 3, or icons 8 to be shown in any shape or size. Such a display can receive such useful information about the product from the central console such as a description 10 of the product associated with the module, and numeric information 3 about the product such as the on hand quantity or the amount being taken, returned or restocked.

Two buttons 5 and 6 are provided, and in this application are labelled in large letters “Return” and “Take” respectively, since that is the most common function in an inventory application, But plus and minus signs are also shown for use in other administrative functions where the words Take and Return might be ambiguous. Alternatively, other symbols such as an up-arrow and down-arrow or other analogous signs may be used instead. A third button 7 is provided for administrative functions, and may be typically made smaller and less obvious than the main function buttons. Access to administrative functions could also be provided by holding down the Take and Return buttons simultaneously, but this functionality is less convenient. In the central console software, users may be restricted or excluded from accessing one or more of the administrative functions accessed through this administration function. If a user has one or more access privileges, and as described here where there are more than one admin functions, the desired function is accessed by pushing the button 7 a number of times in reasonably rapid succession. Each admin function is associated with a specific number of button pushes. Once in the administration function, a single push of the administration button accepts the function that has been performed, or if it is a multi-step function, moves on to the next step. At any point during execution of a function in the administration mode, pressing, and holding the administration button 7 will cancel the changes made, and return the user to the regular home screen.

Other variations of navigating through an administration feature may of course be utilized. Moreover, the devices described herein are not limited to the use of physical buttons or the like but such buttons are presented as examples. Other variations may include alternative mechanisms for actuating or activating features, e.g., touch-sensitive icons, capacitive sensing, etc.

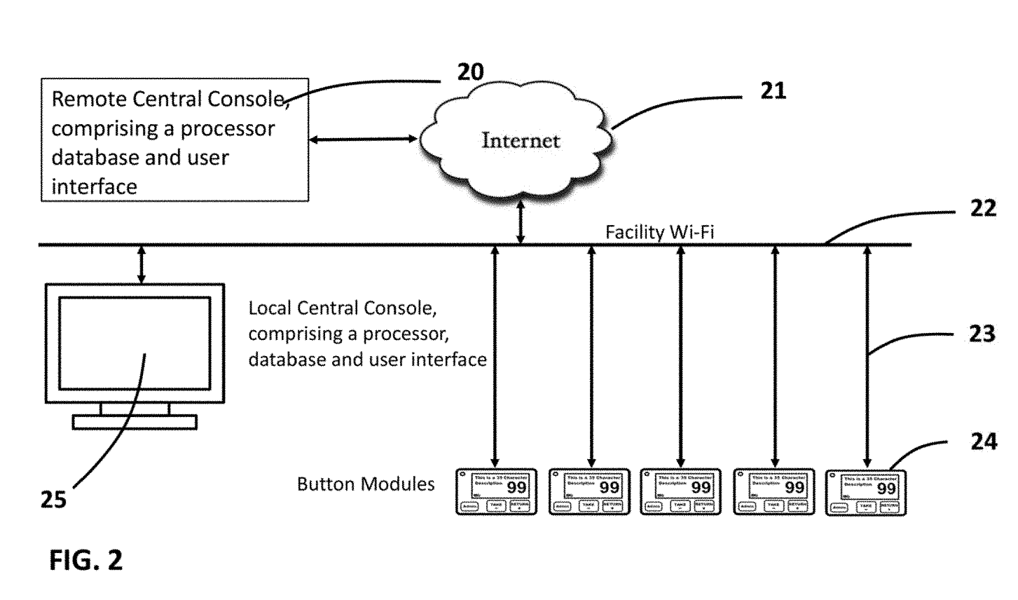

FIG. 2 shows multiple button modules deployed in a network where each button module 24 is equipped with the ability to communicate 23 directly, e.g., through a local Wi-Fi network 22 or other wireless protocol, to a central console containing a database, user interface and processor 25, or which may be local to that facility, or in the cloud 20, accessed through the internet 21, or both.

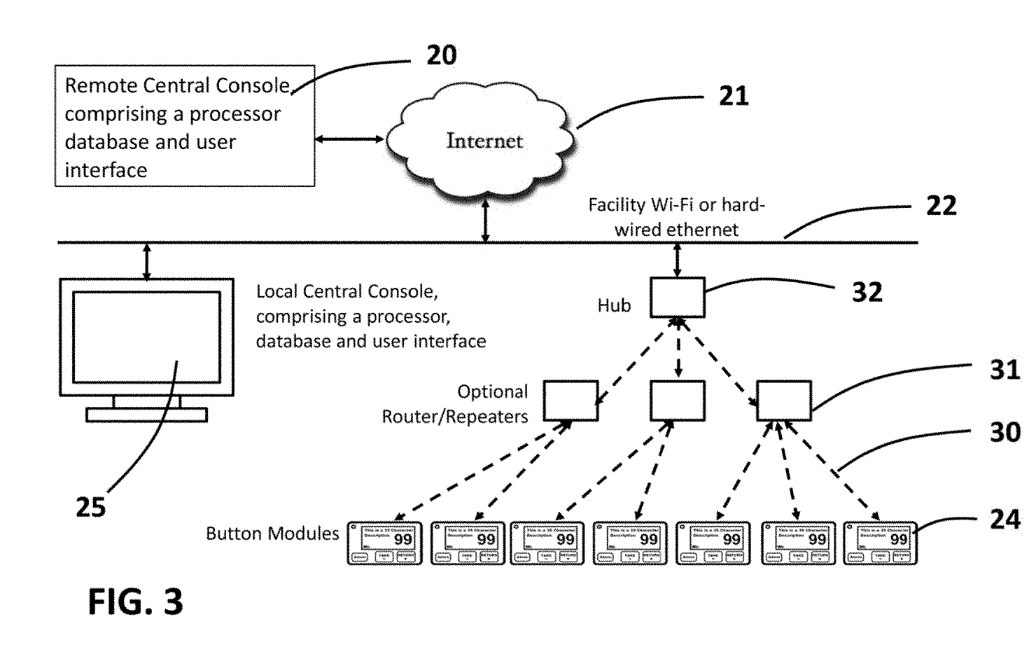

FIG. 3 shows a situation where an intermediate network is used. Because the button modules are battery operated it may be desirable to use a network technology that is short distance and low power such as Zigbee or ZWave. In this case button modules 24 communicate using, e.g., Zigbee transmissions and protocols, over a relatively short distance 30 to a local router 31, and these routers in turn communicate to a central hub 32. The single Hub 32 can communicate over, e.g., Wi-Fi or other wireless protocol, or hard-wired Ethernet with the local central console 25 or the cloud based central console 20 or both.

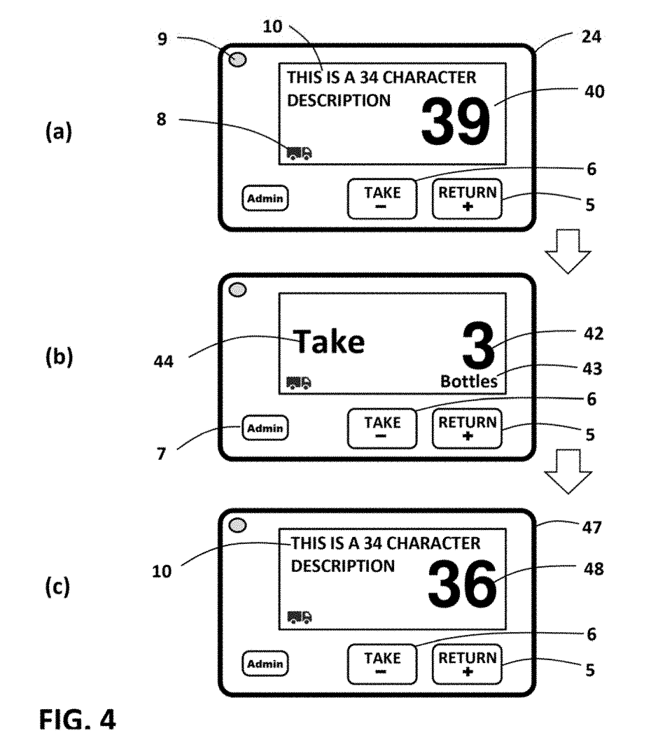

FIG. 4 shows a typical Take (or Return) operation in three steps (a), (b), (c).

FIG. 4 (a) shows the button module 24 in its normal “home screen” state typically displaying the product description 10. A typical product description may be less than, e.g., thirty-four characters, but may be as large as, e.g., sixty-four characters or more, in certain circumstances. The advantage of an electrophoretic display, in contrast to a fixed length alphanumeric display, is that the system software can scale the size of the lettering to be the largest most readable font size that will fit. Typically, the current quantity on hand 40 as held in the central console memory, in this example shown as thirty-nine, is displayed in this normal home screen state. This allows a more experienced user with administration privileges to notice if the actual quantity on the shelf is different, and lets them make a count correction first before taking an item. Note the use of an icon 8, in this case a truck, indicating that more product has been ordered and has shipped and is in transit, Other icons or symbols representative of an action may, of course, be used in other variations.

All that a user, who has logged into the central console, has to do to record the Take (or Return) of an item is to press the Take or Return button, and the result of this action is shown in FIG. 4 (b). The first push of the Take 6 (or Return 5) button in FIG. 4 (a) will cause the display to show the word Take (or Return) 44, so the user knows what the number 42 to the right means. The description 10 has been removed since the user has located the item, but the units of issue 43, in this instance the word “Bottles”, is shown so that the user takes the right quantity. In this example the bottles may be stored on the shelf in cases of six, so the user needs to know are they counting bottles not cases. For a single push of the Take 6 (or Return 5) button, the numeric display 42 will show the number one, in FIG. 4 (b) the numeric display 42 is showing the number three, indicating that the Take button 6 has been pushed three times. Alternatively, the Take button 6 could have been pushed more than required, and then the displayed number 42 is reduced to the correct quantity of three by pressing the Return button 5. Typically, a button module will also be programmed to allow a typematic function so that holding down the Take 6 (or Return 5) button causes the displayed number 42 to decrease (or increase) rapidly, making it more expedient for the entry of large numbers. After a time-out period of no activity at the button module, the software assumes the user has finished their session at that button module, and the display reverts to the home screen shown in FIG. 4 (c). Now that the on-hand quantity 48 is now shown as thirty-six, which is the original on hand of thirty-nine, 40, reduced by the quantity taken of three, 42. Alternatively, to end the session, the user can press the administration 7 button once. Pressing the button on another button module also reverts the display to the home screen on this button module, as does the user logging out of the system. When a button module session is closed out, the item description 10 is returned to the display and the new quantity on hand 48 is displayed.

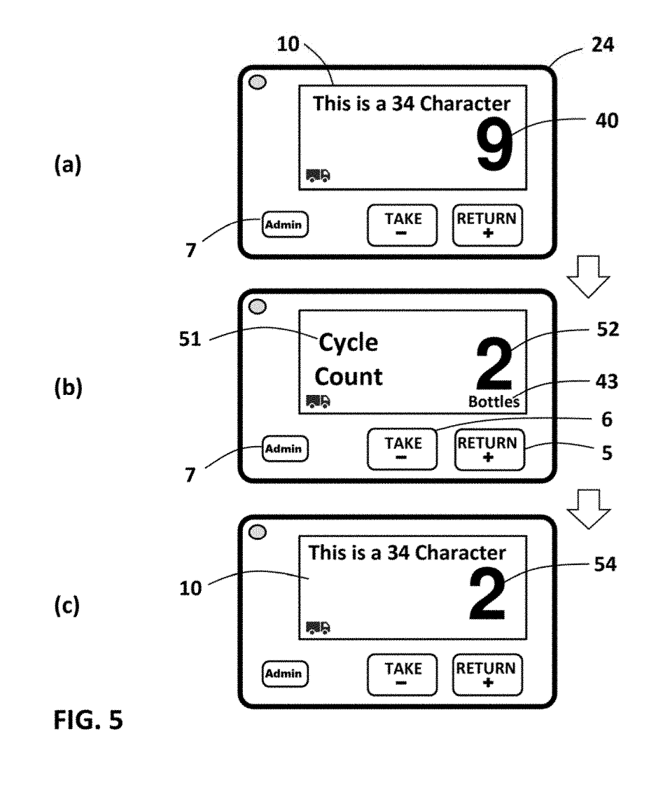

FIG. 5 shows the typical sequence for an ad-hoc cycle-count in three steps, FIG. 5 (a), (b), (c). In FIG. 5 (a) the button module 24 is in its normal home screen, mode displaying the product description 10 and the quantity on hand 40 of nine. If the user has sufficient access privileges and sees that, for example, there are only two items on the shelf, then that user can access the administration mode to cycle count, by pushing the administration button 7 once for example. In FIG. 5 (b) we show that the screen now displays function name cycle count 51, and initially the numeric display 52 will show the previous on hand value of nine 40 together with the units 43. Using the Take button as a minus button 6, this user can reduce the on hand count to two as shown 52, to match the quantity on the shelf. If the on hand needed to be increased the user would use the Return button 5 as a plus button. After a time-out period of no activity at the button module, the software assumes the user has finished their session at that button module, and the display reverts to the home screen shown in FIG. 5 (c). Alternatively, the user can press the administration button once to get to that screen. Pressing the button on another button module also reverts the display on this button module to the home screen as does the user logging out of the system. When this button module session is closed out and returns to the home screen, the item description 10 is returned to the display and the new quantity on hand in this example, of two 54 is displayed.

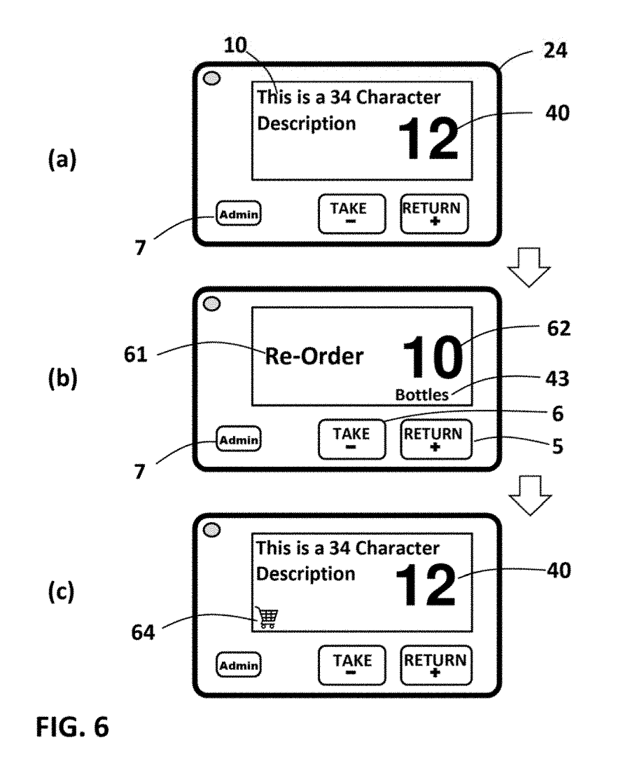

FIG. 6 shows the sequence for doing an instant re-order, as three steps FIG. 6 (a), (b), (c). Items in the system will all have a reorder level set, and when that is value of the on hand quantity is reached the item will be re-ordered up to a maximum quantity. However, a regular ordering system may only re-order once a week. So an alternative is to provide an administration function for immediate reorder. This would for example, allow the central console to place the order immediately or at least at the end of that same day, causing the distributor to expedite replacement items overnight. In FIG. 6 (a) the on hand quantity 40 is shown as twelve, and a user might determine that that is not enough stock to last until the next order period, or may see that that count is wrong and the actual amount on the shelf is not enough. In that case they would access the reorder administration function by pressing the administration button 7 say twice for example, bringing up the reorder function 61 shown in FIG. 6 (b). This screen will initially display the amount to be ordered 62 as zero, then using the Return button 5 the user can increase that quantity, in this example to ten 62. In that process the central console can control the size of the increase in multiples of the minimum order quantity. So for example if this item is shipped in a case of ten bottles, each time the Return or Plus button 5 was pressed the number display 62 would increase by ten bottles. After a time-out period of no activity at the button module, the software assumes the user has finished their session at that button module, and the display reverts to the home screen shown in FIG. 6 (c). Alternatively, the user can press the administration button once. Pressing the button on another button module also reverts the display to this button module's home screen, as does the user logging out of the system. When this button module session is closed out, the item description 10 is returned to the display and the previous, unaltered quantity on hand of twelve is displayed 40. After the process is complete, it can be helpful to show that the item is on this special re-order by displaying an icon such as a shopping cart 64, so another user doesn't repeat the reorder process. When the distributor ships the order this icon can be changed to another symbol, such as the truck 8 shown in FIG. 4 (a) to indicate that delivery is in process.

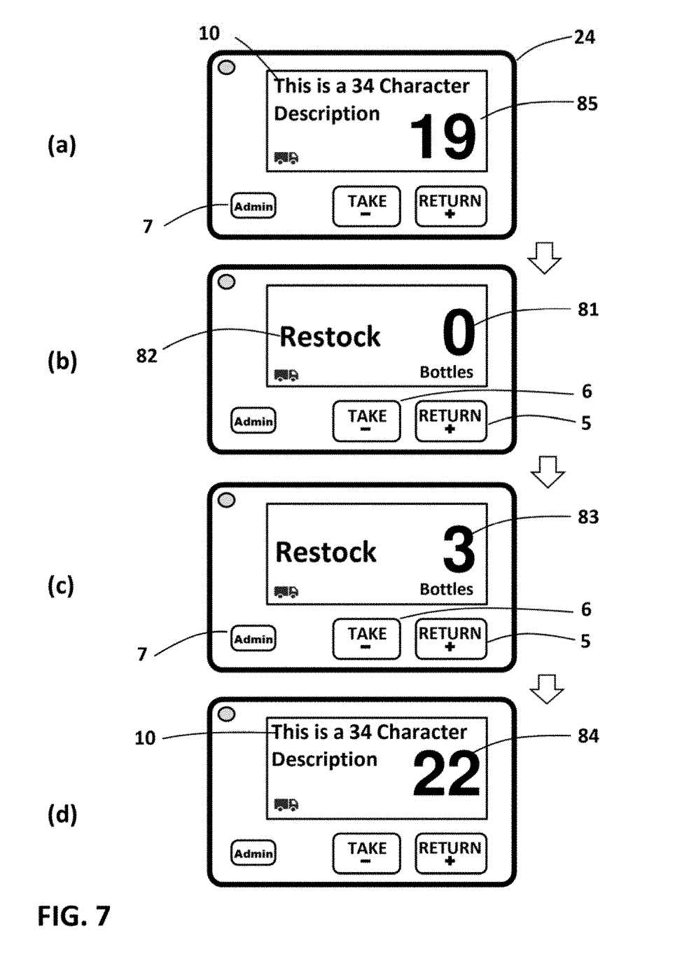

FIG. 7 shows the work flow for supplemental restocking in four steps FIG. 7 (a), (b), (c), (d). FIG. 7 (a) shows the button module in home screen mode. To restock, the user presses the administration button 7, a number of times, for example three times, to get to the restock function. This is displayed in FIG. 7 (b) where the function restock 82 is clearly stated and the initial quantity 81 is shown as zero. The administration user presses the Return 6 button to adjust the quantity and an example is shown in FIG. 7 (c) where the quantity to be restocked of three is shown 83. The restock will be determined to be complete if the user then presses the administration button 7 once, or presses a button on another button module or logs out, or the system times out. When that happens, the button module display reverts to normal home screen mode, as shown in FIG. 7(d), showing the item description 10 and the new on hand of twenty-two 85, being the original amount of nineteen 85 plus the restock of three.

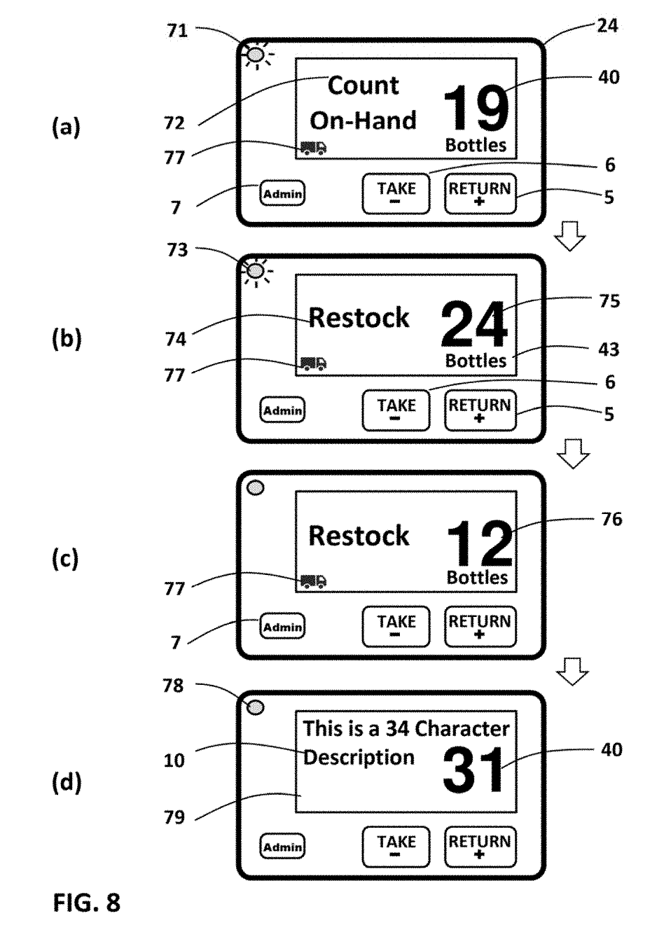

FIG. 8 illustrates the process for a scheduled restocking process, in four steps FIG. 8 (a), (b), (c), (d). scheduled restocking occurs when an order from an individual distributor or supplier is received. The list of items and the quantities is available to the central console, since it placed the order in the first place, and often, if certain items were in short supply, the actual quantities shipped by the distributor will be sent electronically back to the central console 25 of FIG. 2 or FIG. 3. When a user logs into the central console, they can select the list of items they have received and have to restock. At that point the central console can send those values 40 in FIG. 8 (a) over the network to each button module next to items to be restocked, and also start flashing the LED 71 to allow the user to locate the shelf locations. As an option, the button module can be put in cycle-count mode 72 initially, so that the user sees the current on hand quantity of nineteen 40 and with no further action can immediately use the Take 6 or Return 5 buttons to correct that value. Once that is done they can press the administration button 7 once, and the button module will display the change of mode to restock 74, as shown in FIG. 8 (b) and the amount to be restocked of twenty-four 75 and the units 43. If the supplier short-shipped the items, the user can adjust the quantity to be restocked 75 as shown here in FIG. 8 (c) where that number 76 has been decreased to twelve. In this restock process, since the user may wish to just accept the number displayed at the button module, they need to press the administration button to indicate to the central console software that the number has been accepted, and that location is restocked. When that happens the button module display reverts to normal, as shown in FIG. 8 (d), showing the item description 10, and the display showing the new quantity on hand of thirty-one 40 in this example, being the original quantity on hand of nineteen 40 plus the corrected restock quantity of twelve 76 for a total of thirty-one 40. The previously flashing LED 71, is now turned off 78, and any icon showing that stock is on its way 77, is now removed 79. When most of the items have been restocked and when there are on a small number (preferable just one or two) items still to be restocked it, is advantageous for the central console to also enable a beeping signal on the remaining button modules with flashing LEDs. While an audible signal may be hard to locate, it will alert the user that there are still at least one or two items they have missed. If the user logs out of the system or the system times out from a period of inactivity, the central computer will assume that buttons which were set to be restocked but where there was no activity, are locations that have not been stocked.

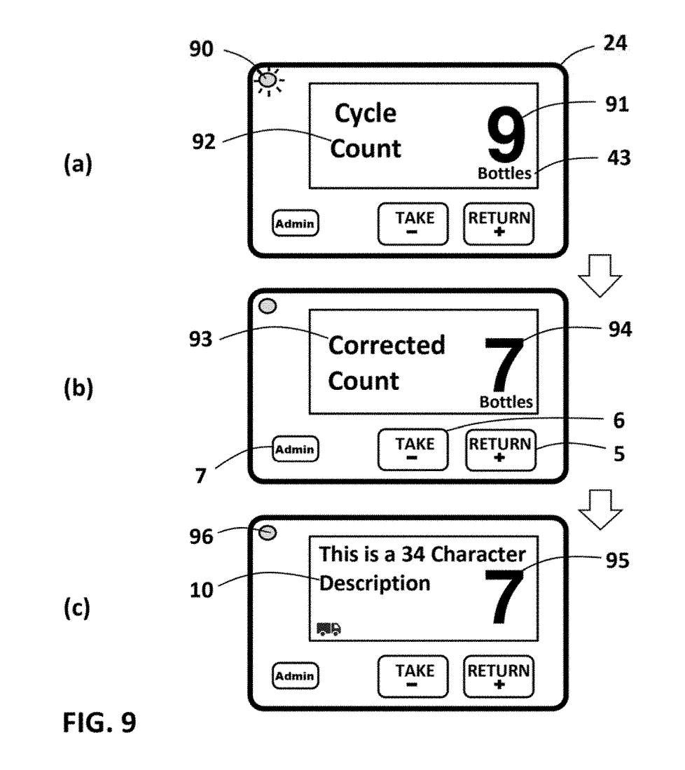

FIG. 9 illustrates the process for a scheduled cycle-count process, in three steps FIG. 9 (a), (b), (c). In large inventory situations it can be laborious to cycle count every item, and so it is desirable to do selective count counts. This selection can be based on items that have been accessed since the last cycle count, or expensive items, or where the stock out would be critical, Such lists can be tracked and selected at the central console 25 of FIG. 2 or FIG. 3. When the user logs into the central console and selects a list of items to be cycle counted, as shown in FIG. 9 (a), the LEDs 90 on each button modules 24 to be counted are set to flashing.

The button modules are put in cycle-count mode 92 initially, so that the user, sees the current on hand quantity of nine in this example 91, and the units 43, and so with no further action, the user can immediately use the Take 6 or Return 5 buttons as shown in FIG. 9 (b) to correct that value and that correction label is displayed 93. If the count is correct, then the user must press the administration button 7 once to let the central computer know that the count has been completed, unchanged, at that location, and at that point the display reverts to the home screen shown in FIG. 9 (c). When this button module session is closed out, the item description 10 is returned to the display and the new on hand quantity of seven 95 in this example is shown, and the LED 96 is no longer flashing. When most of the items have been cycle counted and when there are on a small number (preferable just one or two) items still to be counted it is advantageous for the central console to also enable a beeping signal on the remaining button modules with flashing LEDs. While an audible signal may be hard to locate, it will alert the user that there are still at least one or two items they have missed. If the user logs out of the system, or the system times out from a period of inactivity, the central computer will assume that buttons which were set to be counted, but where there was no activity, are locations that have not been counted. This allows the central console to report accurately on required cycle counting activities.

The applications of the disclosed invention discussed above are not limited to any particular industries, but may include any number of industries and applications. Modification of the above-described methods and devices for carrying out the invention, and variations of aspects of the invention that are obvious to those of skill in the arts are intended to be within the scope of this disclosure. Moreover, various combinations of aspects between examples are also contemplated and are considered to be within the scope of this disclosure as well.

1. A method for recording multiple inventory items by one or more users, comprising:
providing a button module with at least two buttons, and a controllable alphanumeric or bit map display;
providing bi-directional communication to a central console comprising a user interface, processor and database that may be local or in the cloud or both;
displaying on a home screen alphanumeric text related to a physical inventory item adjacent to the location where the button module is placed;
displaying one or more numbers on the screen relating to that item;
detecting the pressing of either of the two buttons on the home screen and sending the number of times each has been pushed back to the central console;
detecting the pressing of a third button at the module, and determining how many times it was pressed over a short period of time;
utilizing the number of presses of the third button within a short period of time to allow the central data base and user interface to modify what is displayed on the button module screen to perform different functions, each function uniquely corresponding to the number of times that third button was pushed during that short period of time;
wirelessly transmitting the number of times the third button was pushed to the central console; and,
displaying information related to an administrative function on the home screen depending upon the number of times the third button was pushed.

2. The method of claim 1 wherein the alphanumeric text on the home screen is the description of an inventory item adjacent to the button module.

3. The method of claim 1 wherein the number displayed on the home screen is the inventory on hand of an inventory item adjacent to the button module.

4. The method of claim 1 where the pressing of a first button increases a number on the screen, and the pressing of a second button causes that same number displayed to be decreased.

5. The method of claim 4 where an initial press of either of two buttons when the home screen is displayed, causes the module to display the number of times that button has been pressed, and transmits that number to the central console.

6. The method of claim 4 wherein when no buttons have been pressed for a period of time the button module display reverts to a home screen display.

7. (canceled) .

8. The method of claim 1 where, when in that administrative mode, or if the central console places the button module in any other mode other than the home screen mode, then if there is no activity for a period of time, or if another button module has user activity, or if the user logs out of the user interface and database, then current values of numeric information on the screen in that mode are transmitted to the database and user interface, and the button module reverts to the home screen display.

9. The method of claim 1 where one of those administrative functions is cycle-counting and the screen text displays a cycle count function and a number is displayed representing the on-hand quantity of the inventory item adjacent to that button module, where pressing the first two buttons adjusts that on hand quantity up and down.

10. The method of claim 9 where pressing the third button once causes the new on hand number to be transmitted to the central database and user interface, and the button module display reverts to the home screen display.

11. The method of claim 1 where one of those administrative functions is Instant Re-Order and the screen text displays an Instant Re-order function and an initial number displayed as zero, representing a quantity of the inventory item adjacent to that button module to be re-ordered, and where pressing the first two buttons adjusts that quantity up and down.

12. The method of claim 11 where the central console sends a minimum order quantity to the button module and pressing the first two buttons adjusts that quantity up and down in increments of that minimum order quantity.

13. The method of claim 11 where pressing the third button once causes the instant re-order quantity displayed, to be transmitted to the central console, and the button module display reverts to the home screen display.

14. The method of claim 1 wherein one of those administrative functions is supplemental restock and the screen text displays restock text indicating a restock process and an initial number displayed as zero, representing a quantity of the inventory item adjacent to that button module to be restocked, and where pressing the first two buttons adjusts that quantity up and down.

15. The method of claim 14 wherein pressing the third button once causes the restock quantity displayed, to be transmitted to the central database and user interface, and the button module display reverts to the home screen display.

16. The method of claim 1 wherein a user at the central console, selects a list of items and associated restock quantities and the central console transmits those quantities for display at each respective button module next to the respective items, causes the button module to display text indicating a restock function is to take place, and causes the respective LED to flash.

17. The method of claim 16 wherein the quantity shown on the button module for restock can be adjusted up or down by the first two buttons.

18. The method of claim 16 wherein the initial display in the restock mode is text representing a cycle count function, and the number displayed is the on hand quantity which can be changed up or down by the first two buttons, and then when the third button is pressed once, that corrected on hand quantity is transmitted to the central console, and the screen then displays text indicating restock mode and the quantity to be restocked.

19. The method of claim 16 wherein pressing the third button once causes the restock quantity displayed, to be transmitted to the central console, and the button module display reverts to the home screen display.

20. The method of claim 1 wherein a user at the database and user interface, selects a list of items to be cycle-counted and the central console transmits those quantities for display at each respective button module next to the respective items, causes the button module to display text indicating a cycle count function is to take place, and causes the LED to flash.

21. The method of claim 20 wherein the on hand quantity shown on the button module for restock can be adjusted up or down by the first two buttons.

22. The method of claim 20 wherein pressing the third button once causes the new on hand quantity displayed, to be transmitted to the central database and user interface, and the button module display reverts to the home screen display.

23. The method of claim 16, wherein, when all but a small number of flashing button modules have been accessed, a beep alert is started on the remaining button modules in addition to the LED flashing, to indicate there are still locations to be restocked.

24. The method of claim 20, wherein, when all but a small number of flashing button modules have been accessed, a beep alert is started on the remaining button modules in addition to the LED flashing, to indicate there are still locations to be counted.

25. A method for recording multiple inventory items, comprising:
displaying a count upon a display screen of a module, wherein the count corresponds to a number of a physical inventory items adjacent to a location of the module;
detecting a first input from a user upon a first user interface of the module, wherein the first input is indicative of a change in the count displayed upon the display screen;
transmitting the first input from the module to a central console located remotely from the module;
detecting for a second input from the user upon a second user interface of the module, wherein the second input corresponds to a particular administrative function depending upon a number of times the second user interface is actuated by the user;
wirelessly transmitting the second input from the module to the central console such that the central console processes both the first input and the second; and
modifying the count displayed upon the display screen via a modifying signal received by the module from the central console.

26. The method of claim 25 wherein displaying a count comprises displaying the count upon an alphanumeric or bit map display.

27. The method of claim 25 wherein the first user interface comprises at least two buttons depressible by the user.

28. The method of claim 27 wherein detecting a first input comprises detecting for either of the two buttons being depressed by the user.

29. The method of claim 25 wherein transmitting the first input comprises transmitting to the central console through a local network.

30. The method of claim 29 wherein transmitting to the central console comprises transmitting through the local network via one or more intermediate hubs.

31. The method of claim 25 wherein detecting for a second input from the user comprises detecting for a number of times that a third button is depressed by the user.

32. The method of claim 25 wherein the particular function is selected from the group consisting of cycle-count, reorder, and restock functions.

33. The method of claim 25 wherein the particular function comprises a cycle-count function wherein the second input correlates to an on-hand quantity of the inventory item.

34. The method of claim 25 wherein the particular function comprises a reorder function wherein the second input correlates to a quantity of the inventory item to be reordered.

35. The method of claim 25 wherein the particular function comprises a restock function wherein the second input correlates to a quantity of the inventory item to be restocked.

36. The method of claim 25 wherein displaying a count further comprises displaying alphanumeric text indicative of a description of the inventory items.

37. The method of claim 25 wherein the first input comprises a first button and a second button, wherein depressing the first button indicates a number of items returned to the inventory items and depressing the second button indicates a number of items taken from the inventory items.

38. The method of claim 25 wherein the module is programmed to revert the display screen to a home screen after a predetermined period of time if the first input is not detected.

39. The method of claim 25 further comprising actuating an indicator on the module when the count corresponding to the number of the inventory item falls below a predetermined value.

40. The method of claim 39 wherein actuating an indicator comprises actuating an auditory and/or visual alert on the module.

41. The method of claim 25 further comprising displaying counts upon display screens of corresponding additional modules, wherein each count corresponds to a number of a physical inventory item adjacent to a location of each additional module.
